(19) United States
(12) Patent Application Publication
(10) Pub. No.: US 2019/0177219 A1
(43) Pub. Date: Jun. 13, 2019

(54) METHOD AND APPARATUS FOR VACUUM INSULATED GLAZINGS

(71) Applicants: Raymond Miller Karam, Santa Barbara, CA (US); Rocco Lafleur, Santa Barbara, CA (US); Robert Hobden, Santa Barbara, CA (US)

(72) Inventors: Raymond Miller Karam, Santa Barbara, CA (US); Rocco Lafleur, Santa Barbara, CA (US); Robert Hobden, Santa Barbara, CA (US)

(21) Appl. No.: 16/306,460

(22) PCT Filed: Jun. 5, 2017
(86) PCT No.: PCT/US2017/036021

§ 371 Date: Nov. 30, 2018

Related U.S. Application Data
(60) Provisional application No. 62/345,663, filed on Jun. 3, 2016.

(51) Int. Cl. C03C 27/10; C03C 27/08; E06B 3/66; E06B 3/677; E06B 3/673

(52) U.S. Cl. CPC C03C 27/10; C03C 27/08; E06B 3/66309; E06B 3/6775; E06B 3/67304; E06B 3/6612

(57) ABSTRACT

A vacuum insulated glazing can be manufactured using a variety of methods. In one embodiment, a glass substrate is patterned and etched to form recesses in the surface of the glass substrate. The recesses or etched areas form a chamber when the glass substrate is bonded to another glass substrate. In another embodiment, nanoparticles and/or microparticles that absorb laser light are positioned between two glass substrates and heated to bond the glass substrates together. In another embodiment, a tempered glass substrate is bonded to another glass substrate to form a chamber between the substrates. The curved edges of the tempered glass are removed to produce a flat vacuum insulated glazing.

### BACKGROUND

There are many applications for which large format substrates need to be bonded together to form optically transparent, thermally insulating, windows or fenestrations. Conventional systems typically employ sputtering of traces or bond-lines on the substrates prior to mating the substrates and oven sintering the sputtered traces to join the substrates. This process requires very large sputtering chambers and or curing ovens. Several inventive approaches that avoid the need to grind and/or polish large substrates, and also eliminate the need for expensive sputtering processes are described in the '884 provisional, referenced at the end of the Detailed Description.

The present disclosure describes further improved methods and systems for bonding large format substrates to make vacuum insulated glazings (VIGs) that may provide valuable benefits in applications including the fabrication of windows for commercial or residential buildings, and containment of toxic components in solar cells. Some of the methods in the present invention may be used in conjunction with techniques described in the '884 provisional.

### DISCLOSURE OF THE INVENTION

A number of embodiments of vacuum insulated glazings are disclosed along with methods for making the same. In one embodiment, a method of making a vacuum insulated glazing comprises forming a mask on a surface of a first glass substrate, etching the surface of the first glass substrate not covered by the mask to form an etched area on the surface of the first glass substrate, bonding the first glass substrate to a second glass substrate, the etched area forming a chamber between the first glass substrate and the second glass substrate, and evacuating the chamber between the first glass substrate and the second glass substrate. The chamber is preferably hermetically sealed and the vacuum insulated glazing is optically transparent.

In another embodiment, a method of making a vacuum insulated glazing comprises positioning nanoparticles and/or microparticles that absorb laser light between a first glass substrate and a second glass substrate, heating the nanoparticles and/or microparticles using a laser to bond the first glass substrate to the second glass substrate and form a chamber between the first glass substrate and the second glass substrate, and evacuating the chamber between the first glass substrate and the second glass substrate.

In another embodiment, a method of making a vacuum insulated glazing comprises bonding a first glass substrate to a second glass substrate to form a chamber between the first glass substrate and the second glass substrate, the first glass substrate comprising tempered glass, removing the edges of the first glass substrate, and evacuating the chamber between the first glass substrate and the second glass substrate. At least one of the first glass substrate and/or the second glass substrate comprises tempered glass.

The Summary is provided to introduce a selection of concepts in a simplified form that are further described below in the Detailed Description. The Summary and the Background are not intended to identify key concepts or essential aspects of the disclosed subject matter, nor should they be used to constrict or limit the scope of the claims. For example, the scope of the claims should not be limited based on whether the recited subject matter includes any or all aspects noted in the Summary and/or addresses any of the issues noted in the Background.

### BRIEF DESCRIPTION OF THE DRAWINGS

The preferred and other embodiments are disclosed in association with the accompanying drawings in which:

FIG. 1A illustrates a view of a vacuum insulated glazing according to one embodiment.

FIG. 1B illustrates a zoomed-in view of part of the embodiment shown in FIG. 1A.

FIG. 2 conceptually illustrates one method of room temperature bonding that may be applied to some embodiments of the present invention.

FIG. 3 conceptually illustrates the use of a nano/microparticle paste that may be used in some embodiments.

FIG. 4 illustrates a cross-sectional view of a vacuum insulated glazing according to one embodiment.

FIG. 5 illustrates spacer posts that may be used in some embodiments.

FIG. 6A illustrates the arrangement of a nano/microparticle paste on a spacer post according to one embodiment.

FIG. 6B illustrates the arrangement of a nano/microparticle paste on a spacer post according to another embodiment.

FIG. 6C illustrates the arrangement of a nano/microparticle paste on a spacer frame according to one embodiment.

FIG. 7 illustrates a method of using clusters of nano/microparticles as spacers according to one embodiment.

FIG. 8 illustrates a method of forming spacer posts and a spacer frame according to one embodiment.

FIG. 9A is a captured image of a vacuum insulated glazing according to one embodiment.

FIG. 9B is a captured image of a vacuum insulated glazing according to another embodiment.

FIG. 10 illustrates a cross-sectional view of a vacuum insulated glazing according to one embodiment.

FIG. 11A conceptually illustrates the removal of curved portions of one substrate of a vacuum insulated glazing according to one embodiment.

FIG. 11B conceptually illustrates the removal of curved portions of two substrates of a vacuum insulated glazing according to one embodiment.

FIG. 12 illustrates a cross-sectional view of a vacuum insulated glazing enclosing photovoltaic devices according to one embodiment.

FIG. 13 illustrates results of a thermal simulation for a vacuum insulated glazing with substrates of equal thickness.

FIG. 14 illustrates results of a thermal simulation for a vacuum insulated glazing with substrates of different thicknesses.

FIG. 15 illustrates a cross-sectional view of a vacuum insulated glazing assembly including a third substrate, according to one embodiment.

FIG. 16 illustrates a cross-sectional view of a vacuum insulated glazing assembly including an insulated perimeter frame, according to one embodiment.

FIG. 17A illustrates a method of tempering outer surfaces of substrates forming a vacuum insulated glazing according to one embodiment.

FIG. 17B illustrates a method of tempering outer and inner surfaces of substrates forming a vacuum insulated glazing according to another embodiment.

FIG. 18A illustrates a system for evacuating and sealing a vacuum insulated glazing according to one embodiment.

FIG. 18B illustrates a system for evacuating and sealing a vacuum insulated glazing according to another embodiment.

FIG. 18C illustrates a system for evacuating and sealing a vacuum insulated glazing according to yet another embodiment.

FIG. 18D illustrates a system for evacuating and sealing a vacuum insulated glazing according to a fourth embodiment.

FIG. 18E illustrates a system for evacuating and sealing a vacuum insulated glazing according to a fifth embodiment, at the evacuation step of the process.

FIG. 18F illustrates the system of FIG. 18E at the sealing step of the process.

### BEST MODE(S) FOR CARRYING OUT THE INVENTION

A vacuum insulated glazing (VIG) unit contains at least two transparent substrates (sometimes individually called glazings), which are bonded around the edges to form an assembly enclosing a hermetically sealed chamber. The chamber is evacuated during or after the bonding process. The substrates are typically glass. Evacuating the space between the substrates effectively eliminates thermal conduction and convection, allowing the assembly to have a very small depth relative to its length and width. For example, a gas-filled glazing unit with length and width of the order of 1 meter would typically require a gap between the substrates in the range 9-16 mm to minimize heat conduction and convection to acceptable levels, but an evacuated unit of the same length and width would provide similar or even better thermal insulation with a chamber depth of only a few hundred micrometers, maybe 100-200 μm. A triple-glazed gas-filled unit would have better performance than a double-glazed gas-filled one but at the cost of significantly increased thickness of the final assembly, with 40 mm being a typical value, while a VIG unit could match its thermal performance with an overall thickness of only about 6 mm. A VIG unit, therefore, typically provides better thermal performance to fenestration systems than comparable non-evacuated glazing units, even triple-glazed ones, and does so with a significantly thinner assembly. In some cases, a VIG unit may also contain several independently evacuated chambers. The vacuum contained between the glazings is typically between 10e⁻⁴ to 10e⁻⁶ Torr.

I. VIG Structure

A. Gap Maintenance

A practical issue that has to be addressed in any VIG is how to maintain a gap of the desired thickness between the substrates, except at the locations where the substrates are bonded. Atmospheric pressure acting on the two outer surfaces of the substrates bounding the chamber causes the substrates to bow towards each other, which in the limit may result in contact, defeating the purpose of the evacuation. Standoffs or spacers of some type are therefore used to keep the plates from collapsing, with the thickness of the standoffs defining the inter-substrate gap, or chamber thickness.

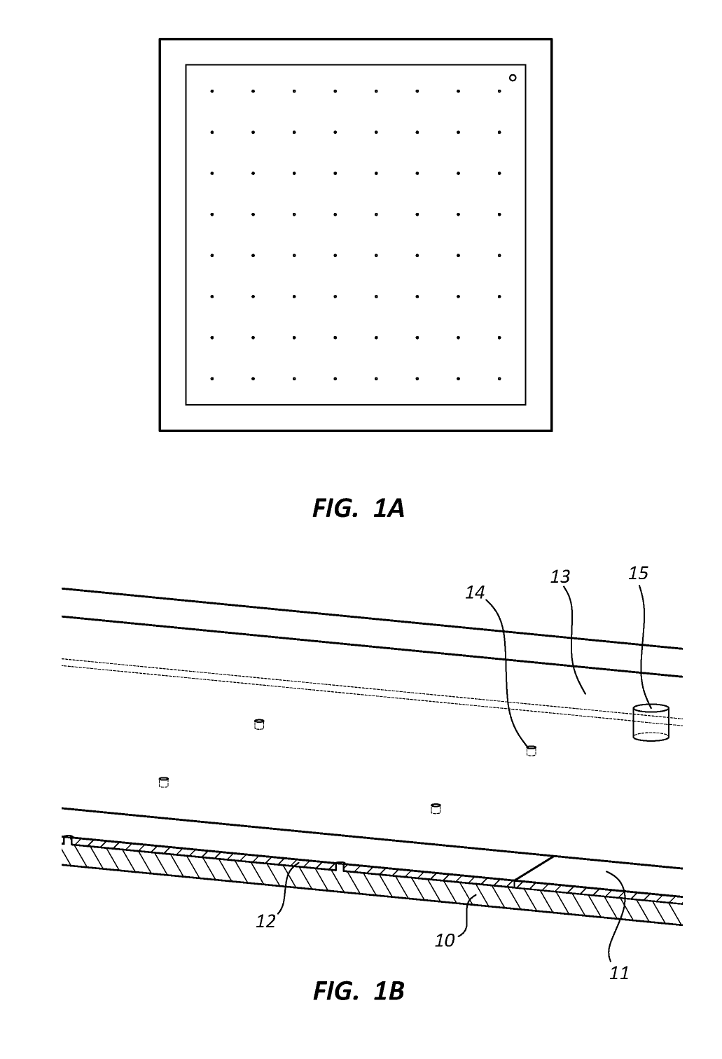

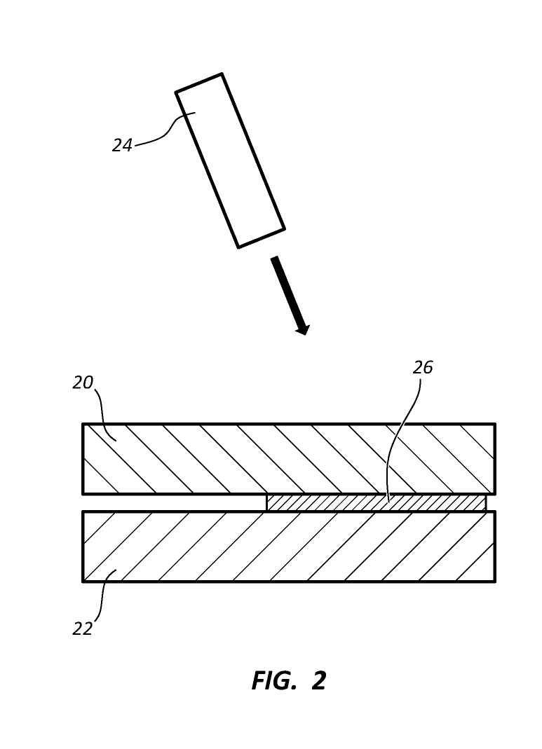

FIGS. 1A and 1B show two views of one example of a layout for a VIG. Two glass substrates 10 and 11 are separated by a spacer frame 13 around the VIG perimeter and spacer posts 14 in the central region. The standoffs (or spacer frame and spacer posts) prevent the substrates from collapsing towards each other, creating chamber 12. The thickness of the standoffs defines the chamber's height. A hermetic bond is created along spacer frame 13 so that the chamber 12 is hermetically sealed. It may be beneficial to bond spacer posts 14 to the two substrates to avoid relative movement between the two substrates when a temperature gradient occurs across the thickness of the bonded assembly.

One bonding method that can be implemented in embodiments of the present invention is room temperature laser bonding (RTB) as described in the '990 patent. This method relies on creating a change in optical transmissivity at an interface between two materials, such that irradiating the interface at a laser wavelength creates a localized high temperature, causing material diffusion and softening of the substrates immediately adjacent the heated interface, forming the desired bond. FIG. 2 illustrates the concept of this bonding method. One implementation of this method that is particularly well suited to un-tempered and flat glass requires the deposition of a thin solid film 26 of an optically absorbing layer of a metal, semiconductor or ceramic on a surface of one of the two substrates 20, 22 to be bonded; laser 24 provides a beam 25 at a wavelength to which substrate 20 is transparent and film 26 is absorbing.

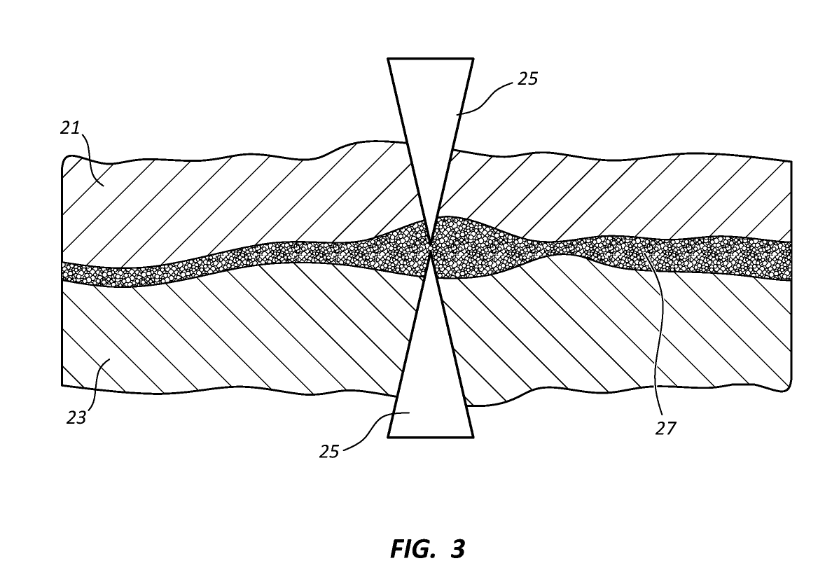

A second implementation of the bonding method particularly suited to situations when one or both substrates 21, 23 is not flat, for example because of a tempering treatment, is described in the '884 provisional, referenced below, and illustrated in FIG. 3. In this case, the optically absorbing layer at the interface is a paste containing nanoparticles and/or microparticles 27, the paste acting as a mechanically compliant as well as light-absorbing medium. The nanoparticles or microparticles may be metallic or dielectric, with one particularly attractive, commercially available choice being titanium oxide nanopowder, but other good choices include chrome, silver, gold, and silicon nitride.

The use of nano/microparticle pastes to enable RTB of tempered and non-flat glass to form VIG units is particularly attractive.

Returning to FIG. 1B, hole 15 allows chamber 12 to be evacuated after the bond is created. Hole 15 may then be plugged using one of various techniques described later in this disclosure. In some embodiments, hole 15 or multiple such holes or perforations are made on one or both substrates, by laser machining or other techniques, prior to bonding.

In some embodiments, where at least one surface of each of the two substrates to be bonded includes a low emissivity (low-E) coating, such as is often provided in glazings, RTB may be carried out making use of the coating as the required absorbing layer. The low-E coating absorbs incident laser radiation to provide a localized high temperature, causing diffusion of the coating into the adjacent, softening substrates, and allowing the desired bond to be formed. In these embodiments, the presence of the coating obviates the need to deposit a heat-absorbing layer on the glazings before RTB can be carried out, making for a particularly convenient assembly process.

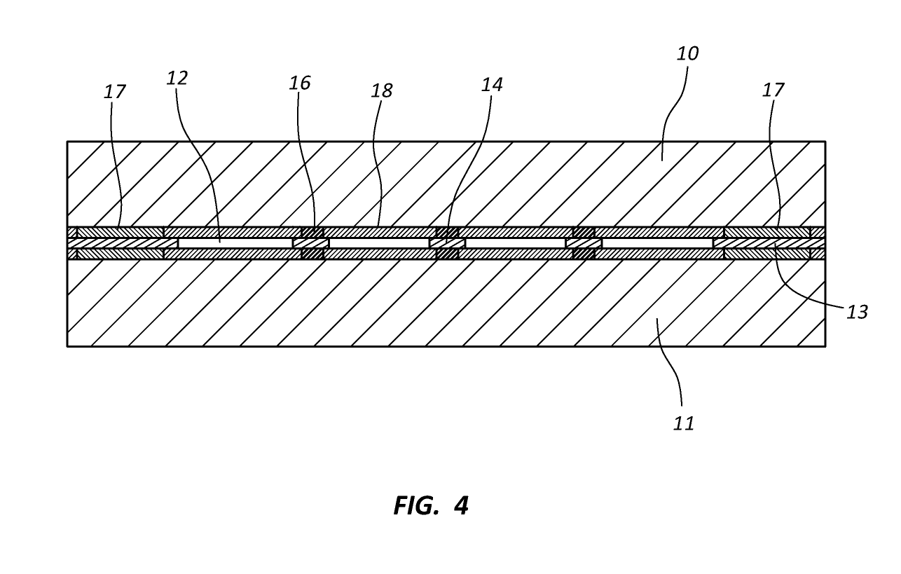

FIG. 4 illustrates a cross-sectional view of a vacuum insulated glazing fabricated according to such an embodiment. Substrates 10 and 11 include low-E coating layers 18 on their inward-facing surfaces. The coating layers 18 are used to form bonds 17 between the substrates and spacer frame 13, and, in most implementations, bonds 16 between the substrates and spacer posts 14. In some embodiments, spacer frame 13 and spacer posts 14 comprise glass. In some embodiments, spacer posts 14 may be glass beads. Spacer frame 13 and spacer posts or beads 14 will act as standoffs, creating gap 12 between the two glass plates 10 and 11, in which a vacuum can be drawn. The two substrates would be sealed along the perimeter of spacer frame 13, aiming a laser from one side or both sides at the same time and performing RTB (as described in the '990 patent referenced below) to create bonds 17. Bonding would, in most cases, also be carried out at the locations of spacer posts 14 to prevent or at least reduce relative motion of the substrates in response to a temperature gradient across the thickness of the assembled VIG. Such a gradient may occur before or after the VIG assembly is installed in its desired location.

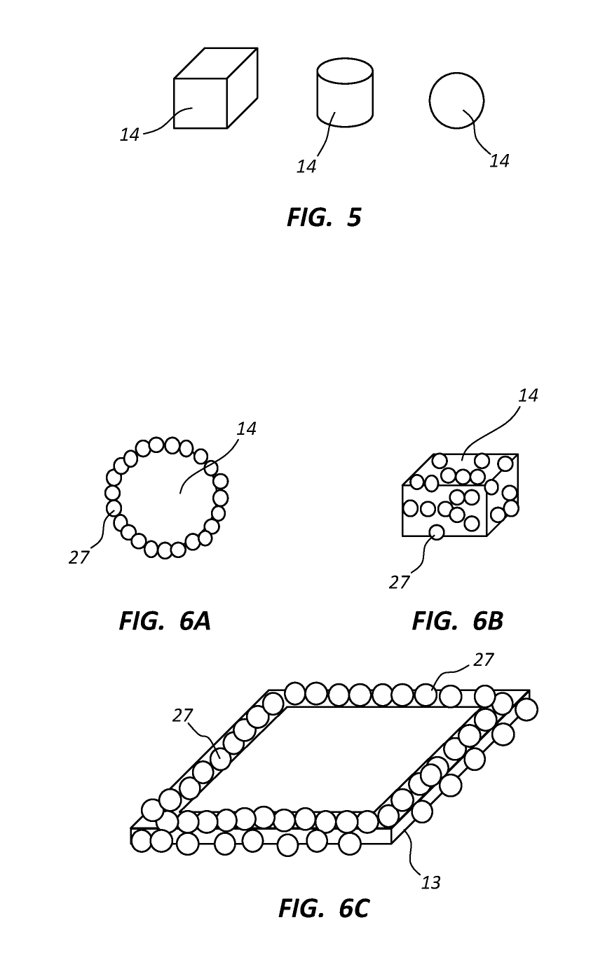

Spacer posts 14 and spacer frame 13 should have a thickness approximately equal to the intended height of the chamber (200 um thick posts and frame, for example, if a 200 um gap is required). Spacer posts 14 may have a rectangular, cylindrical, or spherical shape as shown in FIG. 5, or have some other shape, but be characterized by a specific thickness. Spacer frame 13 may be formed in one single solid piece in cases where the VIG unit is relatively small, for example less than 1 m in each of length and width. In cases where the VIG is larger, as is typical in commercial building fenestration systems, for example, spacer frame 13 may be more conveniently provided by assembling it from separate, equal thickness strips of material (such as glass or Titanium) that are abutted and bonded at corresponding ends using RTB, nanosecond or picosecond welding, or some other convenient attachment technique. The bonding of the components of spacer frame 13 may be carried out before or at substantially the same time that bonding of the frame to the substrates is carried out.

In embodiments where the substrates to be bonded do not have a low-E coating present, RTB may still be used to attach spacer frame 13 and spacer posts 14 to the substrates but only after deposition of an absorbing interlayer between the surfaces to be bonded. Different types of materials such as metals (like Chrome or Titanium), dielectrics (like silicon nitride), oxides (like Titanium Oxide or Aluminum Oxide) or low outgassing polymers (like PARYLENE™) can be deposited as a coating layer on the spacer posts and the spacer frame or on the inward-facing surfaces of the substrates, to act as an absorbing medium for the RTB laser beam as described above.

Another option that may be used is to coat, encapsulate or otherwise surround spacer posts 14 and spacer frame 13 with a paste containing nanoparticles and/or microparticles as shown in FIGS. 6A, 6B, and 6C. The paste can then be laser sintered and bonded to the substrates as described in the '884 provisional, referenced below, and illustrated in FIGS. 6A, 6B and 6C. This approach, as explained above, is particularly useful if the glazing substrates are tempered or un-flat glass. It also reduces transmission of stress through the assembly if and when the VIG unit is subjected to mechanical impact. A low-E coating may be present even in cases where an absorbing paste is used, to minimize thermal radiation losses.

In different embodiments, spacer frame 13 and spacer posts 14 can be made of any one of various different materials such as oxides (like TiO, SiO₂, or Aluminum oxide), metals, glass, dielectrics, low outgassing polymers or other hard materials, or a combination of any of these. One option for creating the standoffs is to use a metal sheet, foil or shim. Good choices for the metal include Titanium or Chrome since their CTE (Coefficient of Thermal Expansion) values are close to the CTE of glass. The foil can be cut (dicing, laser dicing, stealth dicing) or etched (chemical etching) into the desired shapes, placed between the two glass substrates, and then bonded from one side or both sides at the same time as described in the '884 provisional and the '990 patent, referenced below.

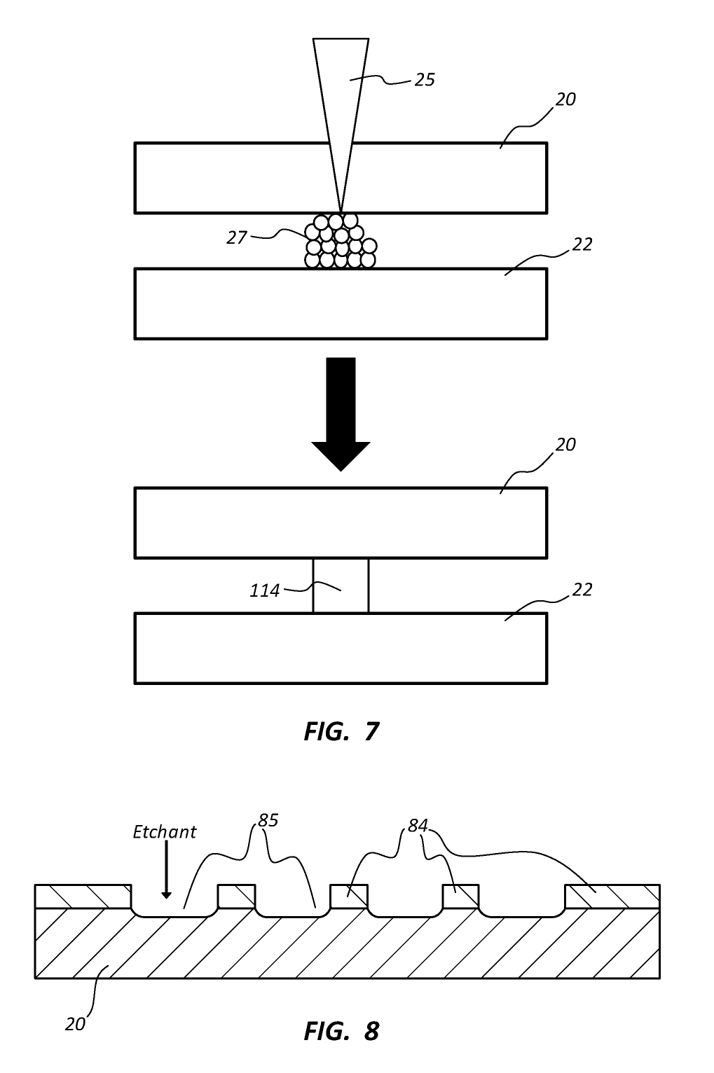

As described above, standoffs 13 and 14 can also be coated or encapsulated by the nano/microparticle paste and be bonded to substrates 10 and 11 by RTB. Another approach to creating easily bondable standoffs is illustrated in FIG. 7, where instead of applying a layer of paste to coat other spacer structures, microparticles and/or nanoparticles 27 are used more directly, being deposited as clusters at the desired locations on the substrates' surfaces, followed by sintering to form the standoffs 114 themselves, and then bonding to the substrates using RTB. To reach the desired height, it may be necessary to deposit a first layer of clusters, sinter it, deposit a second layer, sinter it, and continue the process for as many layers as required; only at the last deposition of clusters will the substrates be mated and the last sintering/bonding run occur

These last two options involving paste or clusters are well suited to the use of tempered or un-flat glass as explained above.

All the embodiments discussed above involve the addition of discrete objects, positioned where required, to contact the approximately planar surfaces of the substrates. In other embodiments, the gap between the substrates and the standoffs that create and maintain that gap may be formed within the substrates themselves, by etching into one or both substrates using a photolithography process, such as with a rolled-on photoresist film mask 84. The photoresist film mask can also be sprayed on the substrate surface or spin coated.

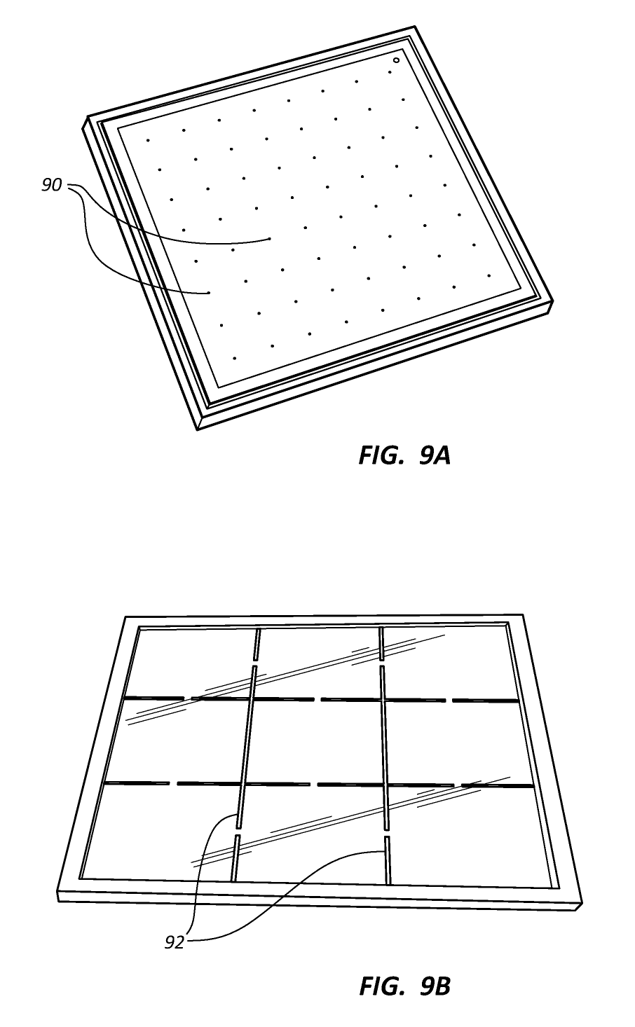

FIG. 8 shows a different but related embodiment employing masking material 84 formed of an acid-resistant tape (like dicing tape or Kapton tape) instead of photoresist film. The tape can be cut simply by a sharp razor blade or more precisely by focusing a laser on its surface and then moving the beam with a laser-scanner or by moving the substrate with a machine. Once the cut is finished, the tape can be peeled to reveal the area 85 to be etched as indicated in FIG. 8. An alternative approach is to cut the tape into the desired pattern first, and then place it onto the surface to mask specific areas.

The spacers or standoffs can take the form of a series of cylindrical posts 90 as seen in FIG. 9A or an arrangement of rectangular beams 92 as seen in FIG. 9B. A grid or mesh pattern may be employed. The substrates can then be bonded by RTB, making use of a Low-E coating if one is already present, or using another coating which has to be deliberately deposited either before rolling the resist or the tape mask, or after etching, as described in the '990 patent, discussed below. The material of the coating may be one or more metals, oxides, or other dielectrics. Alternatively, as discussed above, a nano/microparticle paste can be deposited on the locations to be bonded and used as a compliant and absorbing interlayer. The last options may be particularly appropriate when dealing with tempered or non-flat glass.

Summarizing Section I.A. of this disclosure, different structural approaches can be taken to create and maintain the gap between the substrates of a VIG unit. One category of approaches involves the use of a spacer frame and one or more spacer posts to define the gap between the substrates. The spacer frame and spacer posts can be made of different materials such as glass, metals, oxides, dielectrics, polymers, nano/microparticle paste or other hard materials or a combination of any of these. In other cases, a pattern may be etched into at least one substrate, leaving a raised lip around the perimeter to act as a spacer frame and protruding elements within the central region bounded by the frame to act as spacer posts. Spacer posts and the spacer frame can themselves be coated with different kind of materials as explained above (Low-e coating, metals, oxides, dielectrics, polymers, nano/microparticle paste or other materials with a different transmissivity than that of the substrates) to provide an absorbing medium. Different laser bonding techniques can be used to create the hermetic bond that is required at the location of the frame. RTB is one option, well suited to attaching substrates of flat, non-tempered glass on one of which a thin film of a heat-absorbing coating has been deposited. The use of a nano/microparticle paste as a compliant and absorbing interlayer allows RTB to be used successfully even when dealing with tempered or un-flat glass.

B. Tempered and Non-Tempered Substrates

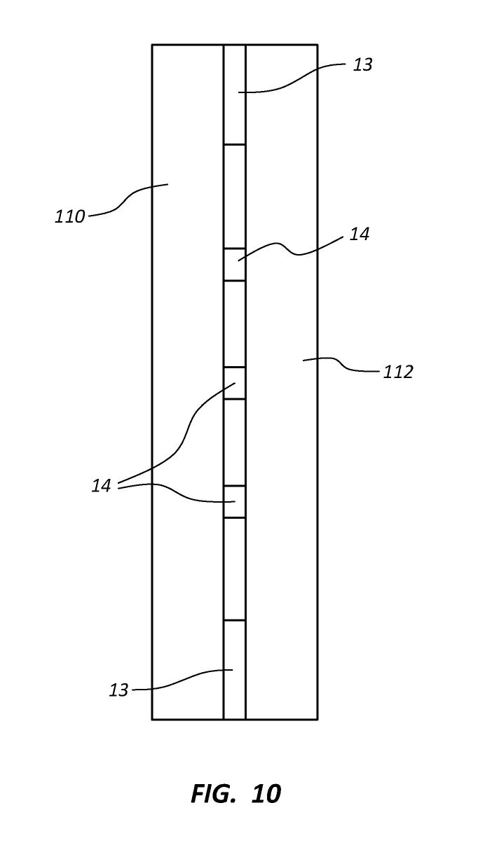

FIG. 10 illustrates one embodiment of the present invention, in which the glass substrate on the left 110 is intended to face the exterior environment (for example as the outer surface of a window in an exterior wall of a building) and is tempered, while the glass substrate on the right 112, facing a more sheltered environment, is not tempered. The tempered outer pane of glass provides the bonded pair with improved fracture strength, while the benefit of the un-tempered inner pane is its relative flatness, allowing the bond to be made more easily than if both panes were tempered, and correspondingly non-planar. The '990 patent, referenced below, explains how RTB, in particular, can be more easily carried out when at least one of the substrates to be bonded is flat.

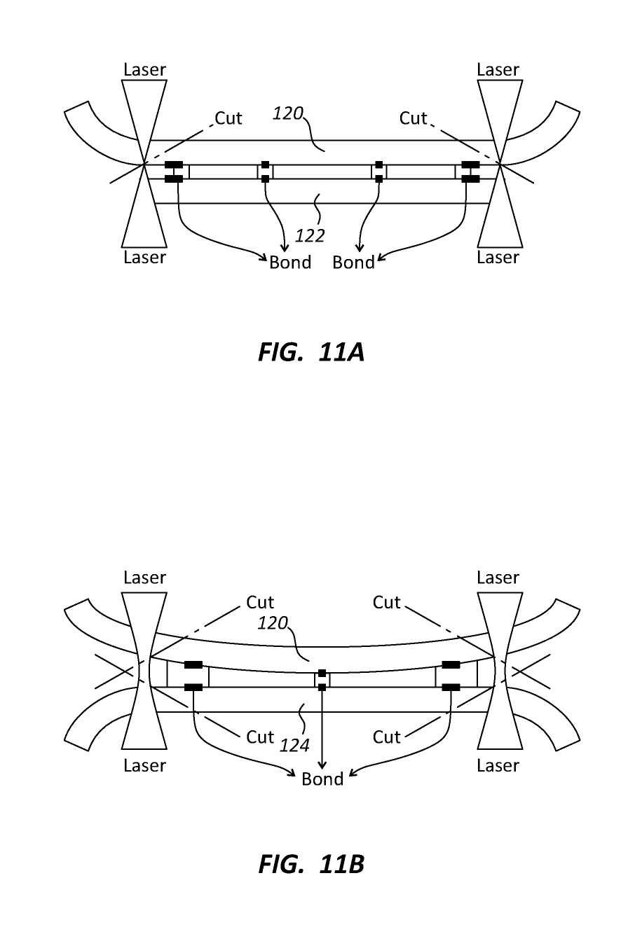

FIGS. 11A and 11B show examples of another approach to dealing with the flatness issue of tempered glass, relying on the fact that the distortion occurs mainly around the edges of a tempered pane, while the remainder remains relatively flat. In the embodiment of FIG. 11A, as in that on FIG. 10, only one of the substrates is tempered, and so this substrate is first deliberately manufactured oversized relative to the desired size of the final assembly. After tempering this oversized substrate 120, bonding (for example by RTB) can be carried out at the perimeter of the non-tempered, smaller pane 122, which lines up with relatively flat portions of the tempered pane. After bonding is complete, the relatively curved sections around the edges of the tempered pane can be cut away, for example using a laser incident from one or both sides. In the embodiment of FIG. 11B, both substrates 120, 124 are tempered, so both have first to be manufactured oversized, then bonded in their correspondingly relatively flat portions, and finally both sets of curved edges have to be cut away, for example using a laser. In both of these embodiments, the regions where the spacer frame is to be attached to the substrates are substantially flatter and easier to bond, especially using RTB, than if the panes had not been manufactured oversized to begin with.

C. VIGs with Photovoltaic or Photoelectric Devices

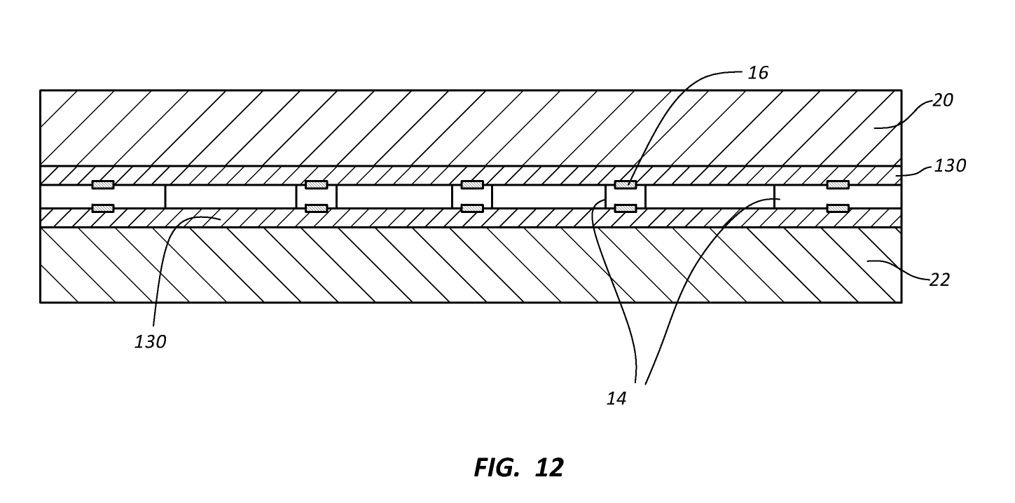

In some embodiments, the VIG assembly may be formed such that an additional element such as a thin film photovoltaic (PV) device and/or a thin film thermolectric device is sandwiched between the substrates before the hermetic seal between the substrates and the spacer frame is created. The additional element (or elements) may be positioned between the spacer frame and the substrate (or substrates) and between the spacer posts and the substrate (or substrates). One such example is illustrated by FIG. 12, a cross sectional view of a VIG that includes two photovoltaic layers, one sandwiched between one substrate and the spacer frame and spacer posts, the other sandwiched between the other substrate and the spacer frame and spacer posts. Each of the photovoltaic layers shown in FIG. 12 may itself include multiple component layers.

One significant benefit of encapsulating a PV device in a VIG assembly is the provision of an optically transparent but hermetically sealed evacuated environment for the device, offering protection from exposure to oxygen, water and other components in the atmosphere, and to the effects of temperature variation. This would improve reliability, reduce maintenance costs, and increase the useful lifetime of the PV device. One category of PV devices that would reap additional benefits is the group that includes toxic materials such as CdTe. In these cases, the hermetically sealed chamber would offer the additional benefit of securely containing the toxic materials, well separated from the external environment.

In some embodiments, photovoltaic layers like those shown in FIG. 12 may serve an additional function beyond energy production in acting as the heat absorbing layers necessary to allow RTB to be carried out. In these cases, there is no need to deposit a heat absorbing layer on the surfaces to be bonded, which is clearly a desirable feature. It should be noted that the low temperatures involved make RTB a particularly desirable choice for bonding VIGs that encapsulate thin films comprising organic or polymer materials, reducing the likelihood of damage to those materials and any metal leads. Such films are increasingly popular choices for third generation photovoltaic cells because they are easy and cheap to make and their absorption spectra can be tuned by molecular engineering. It should be noted that organic photovoltaics can be designed to absorb in the IR region. In this way the glazing would still be transparent in the visible region but absorb in the IR, limiting solar radiation through the glazing.

In other embodiments, a VIG assembly may be formed in a similar way to that described above and shown in FIG. 12, to include a thin film thermoelectric device, that may be as simple as an ITO layer. This device or layer would enjoy the same protection from environmental factors, but also function to generate heat (by applying a voltage) or electricity (in response to the thermal gradient across the VIG). This may be useful in simply acting to oppose or reduce large thermal gradients that might otherwise occur across the thickness of a VIG assembly. In some cases, a VIG assembly may include a PV device and a thermoelectric device, with the latter operating to reduce any tendency of the assembly to bow in response to thermal gradients, and possibly even operating to generate enough heat to improve thermal insulation of the entire system.

D. VIGs Incorporating Substrates of Different Thicknesses

In some embodiments it may be advantageous for the two substrates bounding the evacuated, insulating chamber to have different thicknesses, as a method of reducing visible distortion. Consider the case where the VIG unit is installed in the wall of a building, with one substrate exposed to the temperature of the external environment, while the other substrate experiences the relatively stable thermal environment of a room. Given the superior insulative properties of a VIG unit, the resulting positive or negative temperature differences across the thickness of the unit may cause significant bowing of the substrates, determined by the thermal coefficient of expansion of the substrate material. The resulting distortion of light passing through the VIG unit may be both visible and undesirable to people inside or outside the building, especially when large format glazings are involved, for example in the windows of commercial buildings.

In some embodiments of the present invention, the substrate for the side of the VIG that is facing the environment is chosen to have a much greater thickness than the thickness of the substrate for the opposite, inward facing side. This outer glazing will then have a much greater mass moment of inertia than the thinner, inner glazing, making it much less likely that the bonded assembly will bow in response to thermal differences between the inner and outer environments. Visible distortion is therefore significantly reduced.

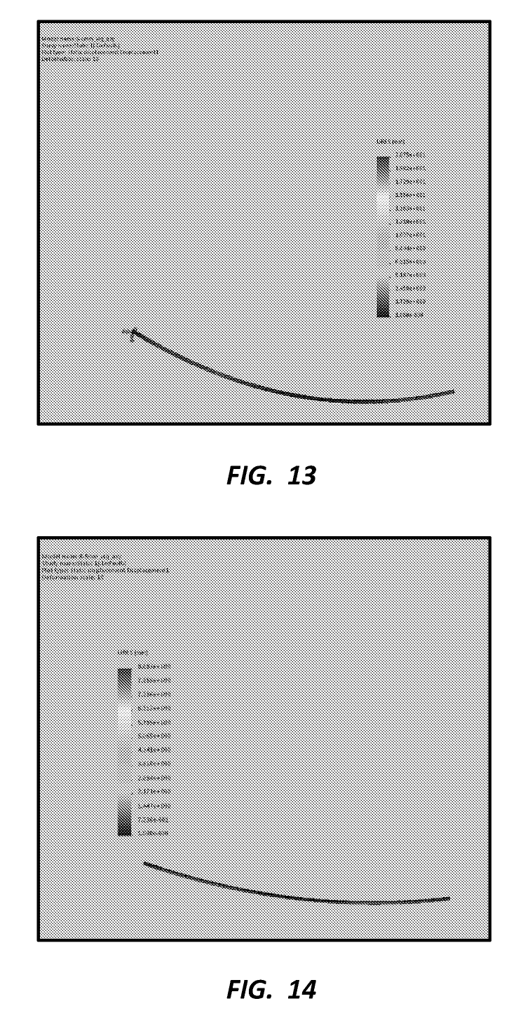

FIGS. 13 and 14 show simulation results for two different types of glazing systems. The first type is a symmetric VIG system comprised of two layers of glass each having a thickness of 6 mm. The second VIG system is comprised of one layer of glass 10 mm thick and a second layer of glass 2 mm thick. Both systems have the same length of 1.5 m and the same temperature difference is applied across the width of the unit. The results clearly show that the first system suffers a much larger deformation (20.8 mm of displacement) than does the second system (8.6 mm of displacement). This improvement of greater than a factor of 2 is achieved although both systems show a very similar stress profile, indicating that the thickness difference does not cause higher stress to be experienced. Such results indicate that there may be significant benefits to designing the VIG assemblies to use substrates of different thicknesses, according to a ratio of, for example, 2:1, 3:1, 4:1, 5:1, 6:1, 3:2, 4:3, 5:3, etc as this can minimize the distortion without adding undesirable additional stress.

E. VIGs with Three Substrates

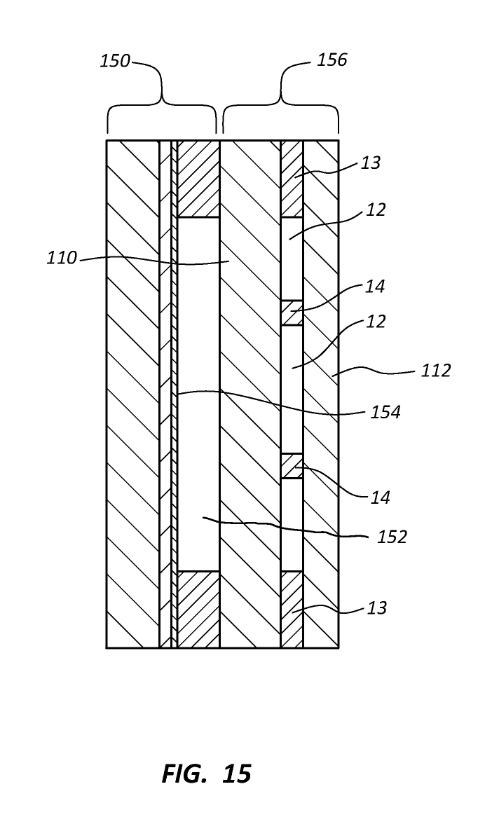

In some embodiments, distortion of the type discussed above due to temperature differences across the VIG 156 assembly may be virtually eliminated by adding a third glazing 150 (can be tempered or non-tempered) to the previously “outer” glazing of the pair making up the VIG unit, as shown in FIG. 15. This third glazing may be bonded to the first pair of substrates in a traditional manner (for example adhesively) to act as a cover glazing. The three glazings may all be tempered, or non-tempered; in some cases, a combination of tempered and non-tempered glazings may be used.

The gap between this third glazing and the previously “outer” glazing need not be evacuated, but may instead be filled with a gas 152 such as argon, a common choice today for conventional double and triple pane glazing units. This offers the advantage of providing an additional layer of protection against breakage upon unintended impact. Also, the third glazing can have a Low-E coating 154.

A low emissivity coating may advantageously be applied to the inside face of the third glazing, as shown in FIG. 15.

F. VIGs with Insulating Outer-Perimeter Frames

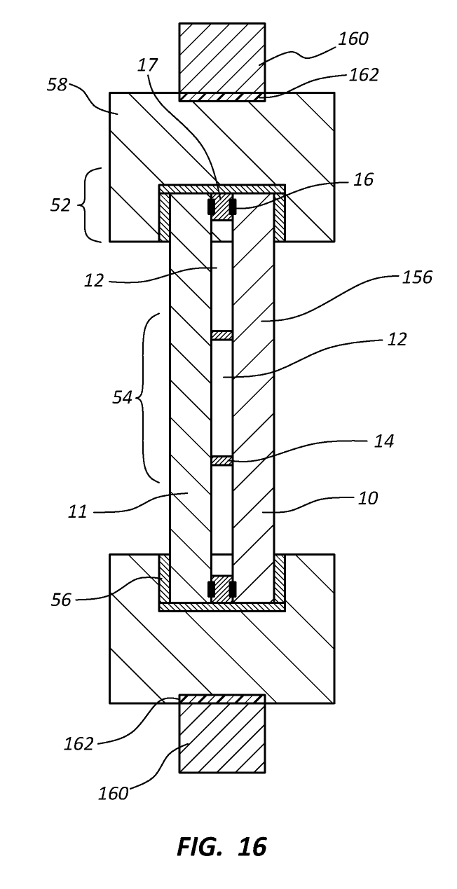

In some embodiments, an insulated glazing unit (IGU) may be assembled by adding an insulating outer-perimeter frame 58 to a VIG unit 156 of any of the types described above. Bonding is carried out at seal 56 between insulating outer-perimeter frame 58 and outer edges of substrates 10, 11 of the VIG unit as shown in FIG. 16. It should be noted that VIG bond 17 between substrates 10, 11 and frame 13 is positioned further from the central axis X-X of the VIG than seal 56 between insulating frame 58 and the VIG. This arrangement minimizes thermal leakage between the user area (on the left hand side of the Figure, marked “Inside”) and the external environment (on the right hand side of the Figure, marked “Outside”). The two substrates 10, 11 will be in contact (through glass-to-glass bonding) on the perimeter of the glazing to form the hermetic chamber 12 as described previously. For this reason, the perimeter contact area 52 will have a higher thermal conductivity in the direction perpendicular or through the thickness of the VIG (parallel to the X-X axis), than the more central areas 54, where the substrates are separated by an evacuated space. In the assembly conceived here, the environment in the room of the building will only be exposed to the evacuated portion 54 of the window, minimizing the thermal exchange between the room and the external environment, outside the building. The perimeter of the vacuum glazing is covered by insulating outer-perimeter frame 58 and can thermally leak only through the building walls 160, which typically also contain an insulation layer 162. In practice, insulating outer-perimeter frame 58 should overlap the outer edges of the VIG in area 52 by 25 mm or more in order to minimize heat conduction through the perimeter of the VIG. In such an arrangement, when used as an insulating window on a building, the combination of insulated outer-perimeter frame 58 and the VIG will provide an IGU with much better thermal insulation than if the substrate-contacting perimeter were directly exposed to the ambient outside temperature and to the inside user area.

II. Post-Assembly Tempering of VIG Substrates

After bonding of the spacer frame and spacer posts to the substrates is completed, typically using annealed, un-tempered glazings, the assembled VIG unit can be tempered either only on the outer facing surfaces of the assembly or on both sides of each glazing of the assembly. Delaying any tempering until after the hermetic seal between the spacer frame and the substrates is completed is highly desirable, as the flatness of the un-tempered substrates significantly simplifies the creation of that hermetic seal.

A typical tempering process for soda-lime glass heats the glass in an oven to approximately 650° C. (1200° F.) then subjects it to a thermal shock, cooling it in air. In this manner, the surface of the glass cools down much quicker than the bulk of the glass, creating a parabolic stress profile through the thickness of the glass, where the outer layers are defect free and in a state of compression. The surface stress is roughly 70 MPa (10 kPSI). Such surface stress enhances the break strength of the glass by a factor of 4.

A. Tempering of Outward-Facing VIG Substrate Surfaces

Tempering is usually done on both sides of a single glazing to avoid introducing bending stress that may break the glass. With a VIG unit that has already been sealed to a spacer frame using RTB (therefore making a glass-to-glass joint), the tempering process may be applied to just one side (the outward facing side) of each of the two substrates to have much the same effect. If the shape of the assembly is designed to be slightly concave before tempering occurs, the tempering process will not put the outward facing surfaces in tension at any point.

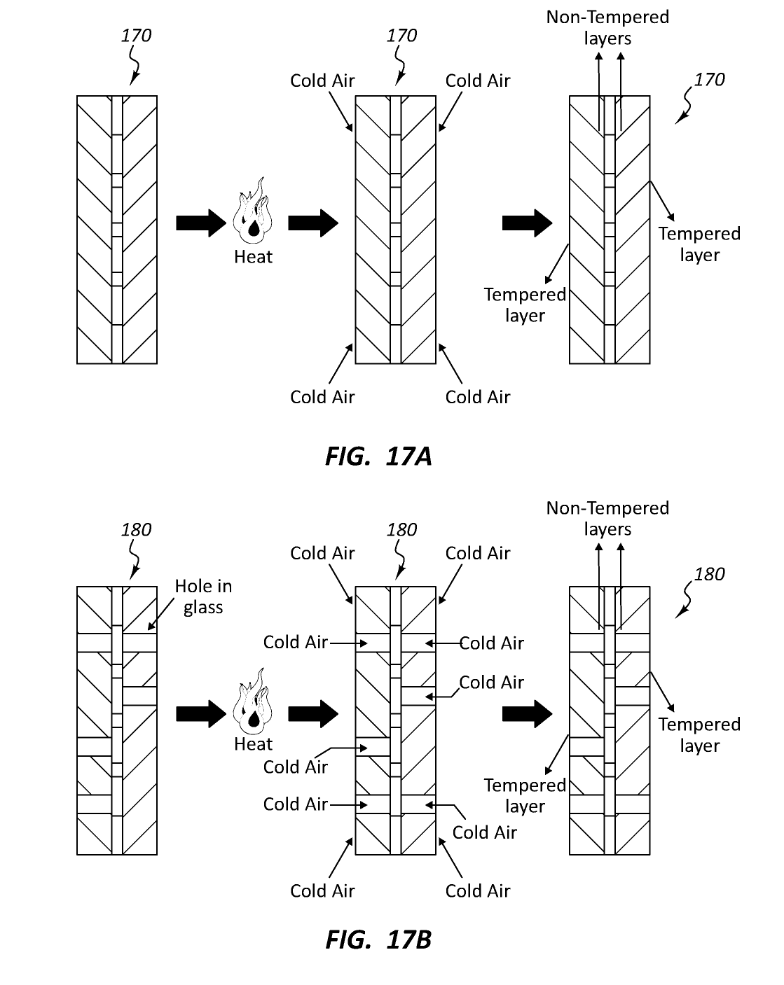

FIG. 17A shows one embodiment, in which a VIG unit 170 is assembled and bonded using annealed non-tempered glass (sealed along the spacer frame and bonded onto spacer pillars). The bonded VIG is then tempered as an assembly, so the whole unit is heated up to the tempering temperature and then the exterior of the VIG is rapidly cooled down. In this way, only the outer facing surfaces of the assembly will be tempered.

B. Tempering of Outward-Facing and Inward-Facing VIG Substrate Surfaces

If all four surfaces (both inward-facing and outward-facing relative to the enclosed chamber) need to be tempered, a slightly different process can be used. One or both glass layers of the VIG need to be perforated with holes along the surface. The holes provide paths for air to access the interior sides of the panes to cool them down rapidly after the relatively slow step of heating in an oven. In this manner, the desired stress profile will be created on all four surfaces, since all of them will have been rapidly cooled down after heating. FIG. 17B illustrates this process. After the rapid cool down, the fully tempered VIG unit 180 may be evacuated through the same holes, and finally the holes may be plugged, according to the methods and apparatuses to described in the following section.

III. Evacuation and Post-Evacuation Sealing of VIG Assemblies

After substrates have been hermetically bonded to enclose a chamber whose thickness is defined by a spacer frame and spacer posts, as described above, the chamber must be evacuated, and the substrate hole or holes through which evacuation is achieved must be sealed.

A. Evacuation and Adhesive Sealing

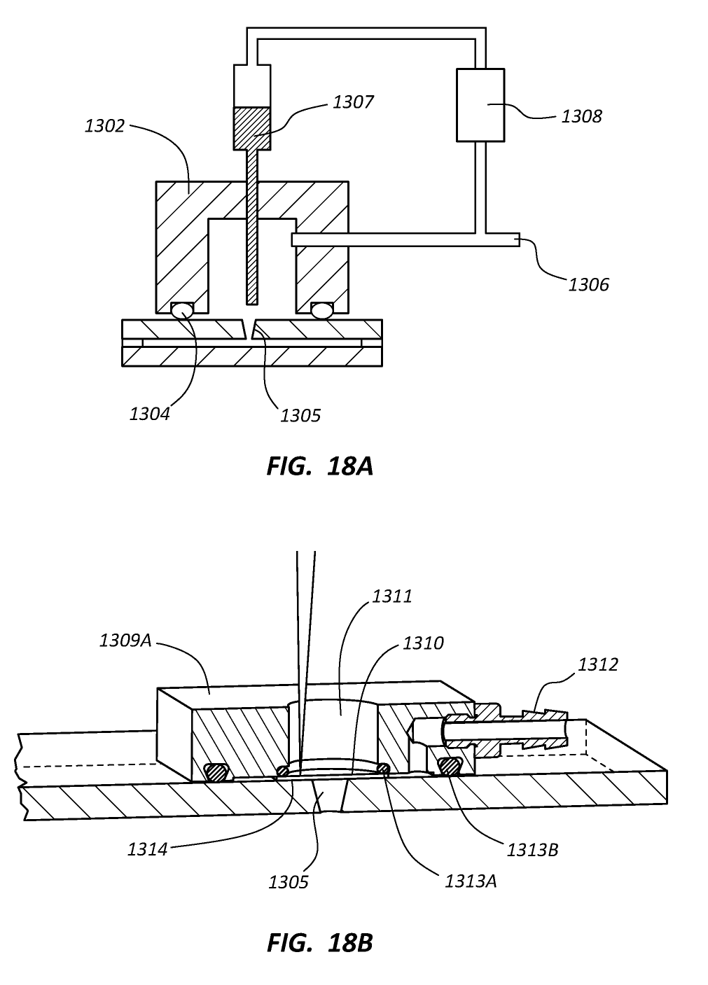

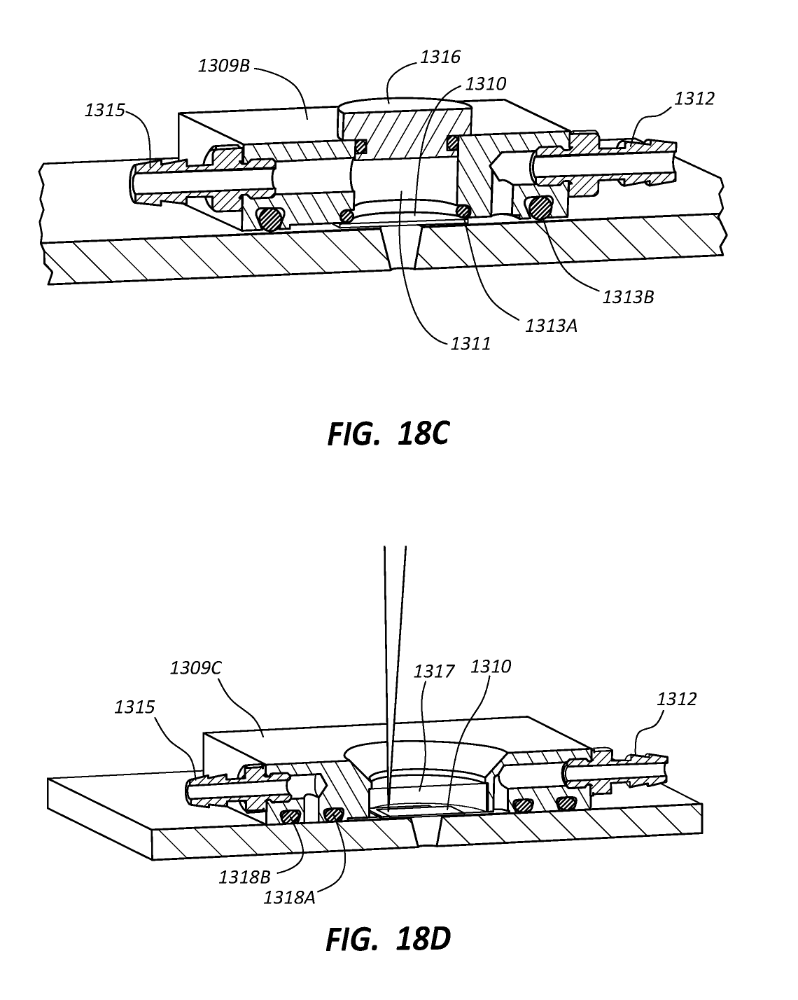

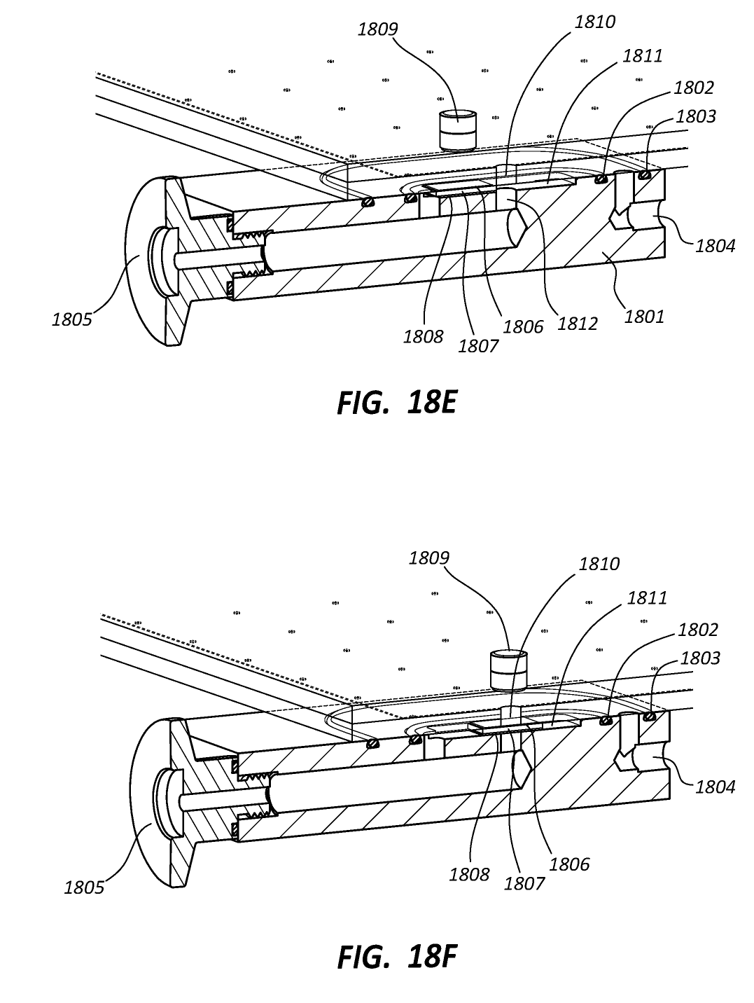

FIG. 18A illustrates one embodiment of a system designed to carry out the evacuation and the sealing of the hole or holes of a VIG unit, using an adhesive. Fixture 1302 includes O-ring 1304 seated against hole 1305 in one substrate of the VIG unit. Fixture 1302 has two connection ports: one connecting through 1306 to a vacuum pump (not shown) and the second one connecting to syringe 1307, which is loaded with adhesive. Syringe 1307 is also connected, through vacuum regulator 1308, to the vacuum pump. The vacuum pump is operated with regulator 1308 fully open (to prevent the adhesive from being drawn into the VIG) so that air is pumped out of the chamber. When the desired level of vacuum is reached, regulator 1308 is partially closed and adhesive from syringe 1307 will start to flow into hole 1305. The adhesive is typically quickly cured with the application of UV light to form a plug, tightly sealing hole 1305. In some embodiments, hole 1305 is conically shaped so that after the VIG is removed from the system, the internal vacuum within the VIG keeps the plug of cured adhesive securely in place, in a self-wedging “keystone” fashion, reducing the exposure of the adhesive/glass bond to shear forces.

B. Evacuation and RTB Hole-sealing

FIG. 18B illustrates one embodiment of a system designed to carry out the evacuation and sealing of the hole or holes of a VIG unit using RTB. Fixture 1309A is designed to room temperature bond a small glass plate 1310 over hole 1305 in the substrate of the VIG. Fixture 1309A has an opening 1311 through which the laser beam of a RTB system (as described in the '990 patent, referenced below) can be focused onto the interface 1314 between the surface of the VIG and glass plate 1310. Fixture 1309A is connected through port 1312 to a vacuum pump (not shown) and includes O-rings 1313A and 1313B, seated on the surface of glass plate 1310 and the upper VIG substrate respectively. When a vacuum is drawn through port 1312, fixture 1309A is held in place on the VIG and on glass plate 1310, while the chamber in the VIG is evacuated through the unsealed interface 1314 between glass plate 1306 and the VIG. Laser bonding through center aperture 1311 can be performed after the desired vacuum is reached, sealing the interface between glass plate 1310 and VIG to completely cover hole 1305.

FIG. 18C illustrates another embodiment of a system designed to carry out the evacuation and RTB hole sealing of a VIG unit more quickly than that shown in FIG. 14B. Fixture 1309B includes port 1312 connected to a vacuum pump as before, but also includes a second port 1315 that can also be connected to a vacuum pump. Controlling the differential vacuum between ports 1312 and 1315 allows glass plate 1310 to be drawn upward to seat against small O-ring 1313A. Plug 1316 is employed to close aperture 1311 accessible to the RTB laser beam. Screws (not shown) or the resilience of O-ring 1313A may be used to raise fixture 1309B and glass plate 1310 slightly above the VIG surface, while large O-ring 1313B maintains a seal to allow evacuation of the VIG chamber to occur. The small gap created between glass plate 1310 and the VIG allows better flow during evacuation. After evacuation of the VIG, fixture 1309B is lowered by adjusting the screws or reducing vacuum in port 1315 until plate 1310 contacts the VIG, plug 1316 is removed, and laser bonding takes place through opening 1311.

In the embodiment shown in FIG. 18C, for the patch 1310 to be pressed against O-ring 1313A the vacuum at port 1315 needs to be better than the vacuum at 1312. Since the level of evacuation in the VIG is provided by 1312 this limits the level of vacuum achievable in the VIG before the differential pressure is too little to push 1310 against 1313A hard enough to seal. An alternative (or addition) to relying on differential pressure across 1310 to provide enough force to seal against O-ring 1313A is to provide clips or magnets to clamp plate 1310 to the fixture.

FIG. 18D illustrates yet another embodiment of a system designed to carry out the evacuation and RTB hole sealing of a VIG unit. Fixture 1309C incorporates window 1317, transparent to the bonding laser, as a replacement for plug 1316 used in the embodiment of FIG. 18C. Window 1317 is mounted by an airtight means (e.g. adhesive, O-ring) into fixture 1309C and used to clamp glass plate 1310 to the VIG. Fixture 1309C is seated against the VIG surface using two O-rings 1318A, 1318B. The VIG is evacuated by applying vacuum to the region inside the inner O-ring 1318A using port 1312. This vacuum also serves to lightly hold fixture 1309C in place on the VIG. The distance of fixture 1309C from the VIG and, if they are in contact, the clamping force applied to glass plate 1310 by window 1317, may be adjusted by varying the pressure between O-rings 1318A, 1318B by applying vacuum on port 1315. Decreasing the pressure draws fixture 1309C toward the VIG, while increasing the pressure allows the elasticity of the O-rings to push the fixture slightly further away from the VIG surface (but remain sealed by O-rings). In this way, a clearance may be created which allows glass plate 1310 to slide sideways under window 1317 to expose hole 1305 or, if the assembly is inverted, to drop by gravity away from the VIG onto window 1317 and create a gap between plate 1310 and the VIG, allowing for rapid evacuation. When vacuum is reapplied between the O-rings on port 1315, fixture 1309C is pulled toward the VIG, clamping glass plate 1310 against the VIG in position for RTB to be carried out. Reference features may be used inside the fixture to help properly locate the glass plate for clamping and bonding.

FIGS. 18E and 18F illustrate a fifth embodiment of a system designed to carry out the evacuation and RTB hole sealing of a VIG unit. Fixture 1801 is sealed against the VIG by two O-rings 1802 and 1803. The VIG is evacuated by applying vacuum to the area within 1802 using port 1805. This vacuum also serves to lightly hold the fixture in place. The distance of fixture 1801 from the VIG and, if they are in contact, the clamping force applied to glass patch plate 1806 by the fixture, may be adjusted by varying the level of vacuum in the area between O-rings 1802 and 1803 by port 1804. The glass plate 1806 sits atop a compliant elastomer pad 1807 and a ferrous metal shim 1808 which slides laterally in a pocket 1811. When the vacuum between 1802 and 1803 is minimal and the O-rings push the tool slightly away from the VIG, the magnetic attraction between magnet 1809 and metal shim 1808 may be used to slide the glass patch 1806 to expose the hole in the VIG 1810 for efficient evacuation (FIG. 18E), or to cover the hole in preparation for sealing (FIG. 18F). With the patch in place, the level of vacuum between 1802 and 1803 is increased, drawing the tool toward the VIG, clamping the patch against the VIG. The elastomer pad 1807 serves to apply and evenly distribute pressure to the glass plate. At this point the magnet may be removed with no resultant motion of the patch 1806 or its backing 1807, 1808. RTB occurs by passing the laser through the glass of the VIG.

Embodiments of the present invention discussed above have been presented primarily within the context of the application of VIG units to fenestration systems for buildings. It should be noted that many of the VIG-related designs and features disclosed may be very useful in other fields where thermal isolation coupled with optical transparency are desired. Such fields include, but are not limited to, improved “windows” for ovens, solar water heaters, refrigerators, and even vehicles.

The above-described embodiments should be considered as examples of the present invention, rather than as limiting the scope of the invention. Various modifications of the above-described embodiments of the present invention will become apparent to t

### ADDITIONAL CONSIDERATIONS

Spatial or directional terms, such as “left,” “right,” “front,” “back,” and the like, relate to the subject matter as it is shown in the drawings. However, it is to be understood that the described subject matter may assume various alternative orientations and, accordingly, such terms are not to be considered as limiting.

Articles such as “the,” “a,” and “an” can connote the singular or plural. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all the items together, or any combination or number of the items. Moreover, terms used in the specification and claims such as have, having, include, and including should be construed to be synonymous with the terms comprise and comprising.

Unless otherwise indicated, all numbers or expressions, such as those expressing dimensions, physical characteristics, and the like, used in the specification (other than the claims) are understood to be modified in all instances by the term “approximately.” At the very least, and not as an attempt to limit the application of the doctrine of equivalents to the claims, each numerical parameter recited in the specification or claims which is modified by the term “approximately” should be construed in light of the number of recited significant digits and by applying ordinary rounding techniques.

All disclosed ranges are to be understood to encompass and provide support for claims that recite any and all subranges or any and all individual values subsumed by each range. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

All disclosed numerical values are to be understood as being variable from 0-100% in either direction and thus provide support for claims that recite such values or any and all ranges or subranges that can be formed by such values. For example, a stated numerical value of 8 should be understood to vary from 0 to 16 (100% in either direction) and provide support for claims that recite the range itself (e.g., 0 to 16), any subrange within the range (e.g., 2 to 12.5) or any individual value within that range (e.g., 15.2).

The drawings shall be interpreted as illustrating one or more embodiments that are drawn to scale and/or one or more embodiments that are not drawn to scale. This means the drawings can be interpreted, for example, as showing: (a) everything drawn to scale, (b) nothing drawn to scale, or (c) one or more features drawn to scale and one or more features not drawn to scale. Accordingly, the drawings can serve to provide support to recite the sizes, proportions, and/or other dimensions of any of the illustrated features either alone or relative to each other. Furthermore, all such sizes, proportions, and/or other dimensions are to be understood as being variable from 0-100% in either direction and thus provide support for claims that recite such values or any and all ranges or subranges that can be formed by such values.

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used in this document shall mean” or similar language (e.g., “this term means,” “this term is defined as,” “for the purposes of this disclosure this term shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained in this document should be considered a disclaimer or disavowal of claim scope.

The subject matter recited in the claims is not coextensive with and should not be interpreted to be coextensive with any embodiment, feature, or combination of features described or illustrated in this document. This is true even if only a single embodiment of the feature or combination of features is illustrated and described in this document.

### INCORPORATION BY REFERENCE

The entire contents of each of the documents listed below are incorporated by reference into this document. If the same term is used in both this document and one or more of the incorporated documents, then it should be interpreted to have the broadest meaning imparted by any one or combination of these sources unless the term has been explicitly defined to have a different meaning in this document. If there is an inconsistency between any of the following documents and this document, then this document shall govern. The incorporated subject matter should not be used to limit or narrow the scope of the explicitly recited or depicted subject matter.
U.S. Prov. App. No. 62/345,663, titled “Method and Apparatus for Vacuum Insulated Glazings,” filed on 3 Jun. 2016.
U.S. Prov. App. No. 62/287,884, titled “Method and Apparatus for Room Temperature Bonding Substrates,” filed on 27 Jan. 2016 (the '884 provisional).
U.S. Pat. Pub. No. 2016/0185081 (application. Ser. No. 14/976,475), titled “Kinetically Limited Nano-scale Diffusion Bond Structures and Methods,” filed on 21 Dec. 2015, published on 30 Jun. 2016 (the '081 application).
U.S. Pat. No. 9,440,424 (application. Ser. No. 14/270,265), titled “Methods to Form and Dismantle Hermetically Sealed Chambers,” filed on 5 May 2014, issued on 13 Sep. 2016 (the '424 patent).
U.S. Pat. No. 9,315,417 (application. Ser. No. 13/769,375), titled “Attachment of a Cap to a Substrate-based Device With In Situ Monitoring of Bond Quality,” filed on 17 Feb. 2013, issued on 19 Apr. 2016 (the '417 patent).
U.S. Pat. No. 9,492,990 (application. Ser. No. 13/291,956), titled “Room Temperature Glass-to-Plastic and Glass-to-Ceramic/Semiconductor Bonding,” filed on 8 Nov. 2011, issued on 15 Nov. 2016 (the '990 patent).

1. A method of making a vacuum insulated glazing comprising:
forming a mask on a surface of a first glass substrate;
etching the surface of the first glass substrate not covered by the mask to form an etched area on the surface of the first glass substrate;
bonding the first glass substrate to a second glass substrate, the etched area forming a chamber between the first glass substrate and the second glass substrate; and
evacuating the chamber between the first glass substrate and the second glass substrate; wherein the chamber is hermetically sealed and the vacuum insulated glazing is optically transparent.

2. The method of claim 1 wherein the mask comprises photoresist.

3. The method of claim 2 comprising exposing the photoresist to ultraviolet light through a photomask to define a pattern on the photoresist.

4. The method of claim 2 comprising removing the photoresist after etching the surface of the first glass substrate.

5. The method of claim 1 wherein the mask comprises an etchant resistant tape.

6. The method of claim 5 wherein the etchant resistant tape comprises acid resistant tape.

7. The method of claim 1 wherein etching the surface of the first glass substrate comprises chemically etching the surface of the first glass substrate.

8. The method of claim 1 wherein the first glass substrate is bonded to the second glass substrate using a room temperature laser bonding process.

9. The method of claim 1 comprising:
forming a mask on a surface of a second glass substrate;
etching the surface of the second glass substrate not covered by the mask to form an etched area on the surface of the second glass substrate; and
bonding the first glass substrate to the second glass substrate, the etched area on the first glass substrate and the etched area on the second glass substrate combining to form the chamber between the first glass substrate and the second glass substrate.

10. A method of making a vacuum insulated glazing comprising:
positioning nanoparticles and/or microparticles that absorb laser light between a first glass substrate and a second glass substrate;
heating the nanoparticles and/or microparticles using a laser to bond the first glass substrate to the second glass substrate and form a chamber between the first glass substrate and the second glass substrate; and
evacuating the chamber between the first glass substrate and the second glass substrate; wherein the chamber is hermetically sealed and the vacuum insulated glazing is optically transparent.

11. The method of claim 10 wherein the nanoparticles and/or microparticles comprise a metal and/or a dielectric.

12. The method of claim 10 wherein the nanoparticles and/or microparticles comprise titanium oxide, chrome, silver, gold, and/or silicon nitride.

13. The method of claim 10 wherein the nanoparticles and/or microparticles comprise titanium oxide nanopowder.

14. The method of claim 10 wherein at least one of the first glass substrate and/or the second glass substrate comprises tempered glass.

15. The method of claim 10 comprising positioning a paste comprising the nanoparticles and/or microparticles between the first glass substrate and the second glass substrate.

16. The method of claim 10 comprising sintering the nanoparticles and/or microparticles.

17. The method of claim 10 comprising coating a spacer post and/or a spacer frame with the nanoparticles and/or microparticles.

18. The method of claim 10 wherein the nanoparticles and/or microparticles are heated to bond the first glass substrate to the second glass substrate using a room temperature laser bonding process.

19. A method of making a vacuum insulated glazing comprising:
bonding a first glass substrate to a second glass substrate to form a chamber between the first glass substrate and the second glass substrate, the first glass substrate comprising tempered glass;
removing the edges of the first glass substrate; and
evacuating the chamber between the first glass substrate and the second glass substrate; wherein at least one of the first glass substrate and/or the second glass substrate comprises tempered glass; and
wherein the chamber is hermetically sealed and the vacuum insulated glazing is optically transparent.

20. The method of claim 19 wherein the second glass substrate comprises tempered glass.

21. The method of claim 20 comprising removing the edges of the second glass substrate.

22. The method of claim 19 wherein the second glass substrate is not tempered glass and the first glass substrate is oversized relative to the second glass substrate.

23. The method of claim 19 wherein the first glass substrate is bonded to the second glass substrate using a room temperature laser bonding process.
